(19) United States
(12) Patent Application Publication
(10) Pub. No.: US 2010/0266803 A1
(43) Pub. Date: Oct. 21, 2010

(54) WALLBOARD TAPE

(76) Inventor: John S. Conboy, Chesterfield, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/501,405

(22) Filed: Jul. 10, 2009

Related U.S. Application Data
(60) Provisional application No. 61/170,716, filed on Apr. 20, 2009.

(51) Int. Cl. E04F 13/076; B32B 3/02; B32B 5/26

(52) U.S. Cl. 428/61; 428/411.1; 428/426; 428/480; 428/533; 428/189

(57) ABSTRACT

A wallboard including a base tape of nonwoven fibers. The fibers include of from about 75%-25% rigid fibers and 25%-75% flexible fibers. Opening are defined between the fibers. A plurality of discrete fibers are adhered to the base tape to form a topcoat. The topcoat fibers include a different material than those of the base tape. The topcoat fibers not covering or filling all of said opening such that said openings are capable of receiving a wallboard compound when applied thereto.

The present application claims priority to U.S. Provisional Patent Application No. 61/170,716 filed Apr. 20, 2009, the contents of which are incorporated herein by reference.

### FIELD OF THE INVENTION

This invention relates generally to the field of wallboard tape.

### BACKGROUND OF THE INVENTION

Present paper wall board tapes have certain drawbacks. Specifically, a difficulty with paper tape is that it tends to absorb water and soften when applied over thick amounts of compound as is necessary when taping irregular joints and corners. When the paper softens it sages and deforms, and a straight line corner is not achieved. Thus, paper must be applied over thin layers of compound which requires a number of coats of compound or the imperfections must be pre-filled, increasing labor costs and time of finishing.

Additionally, paper-based wallboard tape provides a growth medium for mold. Indoor mold growth is becoming an increasing concern as molds reduce interior air quality and in some cases can be toxic. However, thus far, no mold-resistant alternative to paper tape has been produced that can be as cheaply produced as paper tape.

Moreover, paperless wallboard configurations have been introduced into the market. Therefore, in order to reap the mod-resistant benefits of paperless wallboard, a paperless wallboard tape must be implemented. As a result, there is a need in the art for a mold resistant tape for taping wallboard seams that can be produced as cheaply as common paper tape.

### DESCRIPTION OF THE DRAWINGS

FIG. 1 is a plan view of the wallboard tape according to an embodiment of the present invention;

FIG. 2 is a plan view of the wallboard tape according to another embodiment of the present invention;

FIG. 3 is a plan view of the wallboard tape according to another embodiment of the present invention;

FIG. 4 illustrates a process of manufacturing wallboard tape according to an embodiment of the present invention; and

FIG. 5 is a plan view of the wallboard tape according to another embodiment of the present invention.

### SUMMARY OF THE INVENTION

The present invention provides a wallboard comprising a base tape of nonwoven fibers. The fibers comprise of from about 75%-25% rigid fibers and 25%-75% flexible fibers. Opening are defined between the fibers. A plurality of discrete fibers are adhered to the base tape to form a topcoat. The topcoat fibers comprise a different material than those of the base tape. The topcoat fibers not covering or filling all of said opening such that said openings are capable of receiving a wallboard compound when applied thereto.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The preferred embodiment of the present invention comprises a fiberglass and polyester based wallboard tape having a flocked surface of small fibers. The fiberglass fibers provide tensile strength and the polyester fibers maintain flexibility of the tape, as the fiberglass fibers alone tend to break when folded such as when used to tape interior or exterior corners of wallboard. Additionally, the present invention does not develop hairline cracks due to the shrinkage of drywall over time, as does traditional paper tape. The tape can elongate with the moving wallboard and can be repaired if it should crack without removing the tape form the wall, the installer just fill the crack with spackle or paint.

Moreover, it is not possible for a drywall installer to wipe too much wallboard compound from the tape, as it will not “fluff up” to create fuzzy areas to which paint does not neatly adhere, as does paper tape. Additionally, wallboard tape of the present invention when installed in the same manner as paper tape produces a joint that is 0.020″ thinner than using common paper based tape because compound comes through the tape, thereby making drywall butt joints easier to finish.

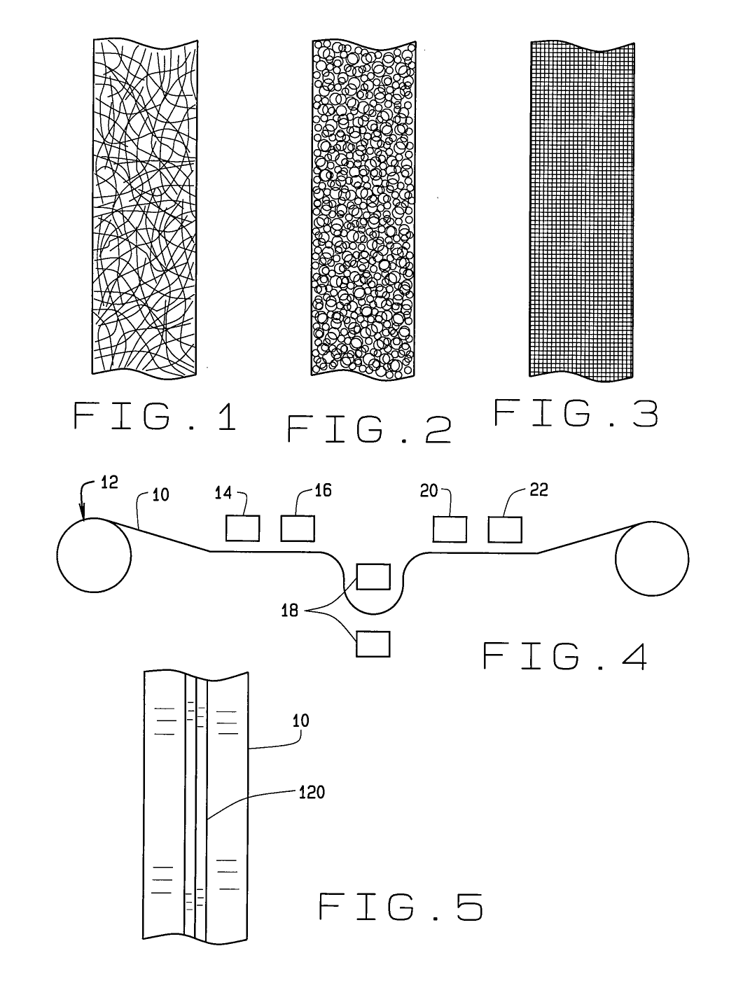

Referring to FIG. 1, a length of wallboard base tape 10 according to an embodiment of the present invention is provided. The wallboard base tape 10 comprises a fiber having a length of ⅜″ to 1⅛″, more preferably ½″ to 1″, even more preferably ⅝″ to ⅞″ fibers and most preferably ¾″ fibers or mixtures of fibers within said ranges or any subcombination of upper and lower limit fiber lengths. The fibers are preferably between 25%-75% polyester fibers and 75%-25% fiberglass fibers, more preferably 33⅓%-66⅔% polyester fibers and 66⅔%-33⅓% fiberglass fibers, and for many applications most preferably 50% polyester fibers and 50% fiberglass fibers. While 50% polyester fibers and 50% fiberglass fibers is most preferred in some situations, such as butt joints, in situations where it is expected that the wallboard tape will be folded such as interior corners and certain exterior corners, a mixture of 75% polyester and 25% fiberglass is most preferred.

The fibers may be laid down in a random fashion as shown in FIG. 1 such that the fibers are not oriented in any certain direction to provide strength in multiple directions. The fibers are preferably laid and not woven. Alternatively, the fibers may be laid in circular patterns or “spun bound” as shown in FIG. 2, said configuration also providing strength in every direction. Alternatively, the fibers may be laid in both horizontal and vertical directions to provide both lateral and longitudinal strength of the tape 10.

The thickness of the base tape 10 is preferably about 7.0 mils or about 0.18 mm. Because the base tape 10 comprises laid fibers, the base tape 10 comprises open space between the fibers through which air and wallboard compound may pass to adhere a finished wallboard tape, as discussed below, to a wall. Preferably, the base tape 10 is 2″ wide but may also be made in 10″ widths for patching drywall damage.

The base wallboard tape 10 as provided above is next provided in a spool to a flocking process as described below. The flocking process, as shown in FIG. 4, comprises a first spool 12 of fiberglass tape 10 as provided above. The spool 12 is unrolled and passed through a coater 14 whereby an adhesive is applied to a side of the tape 10. Next, the tape is fed through a flocker 16 whereby a flocking material is applied to the adhesive covered tape. The flocking material is preferably fibers of nylon, rayon, dacron, polyester, cotton or other cellulose, or other similar fibers or combinations of fibers. The preferred fibers are fibers which are water impervious and therefore will not promote the growth of mold. The most preferred flocking material is nylon. After the flocker 16, the base tape 10 is fed through an oven 18 which heats the glue and flocking material to better adhere the glue and flocking material to the base tape 10. At this point the process is optionally complete; however, in a more preferred embodiment the base tape 10 passed through a chiller 18 which completes the adherence of the glue and flocking material to the base tape 10. The base tape is then passed through a second coater 20 and flocker 22 to apply a second coating of adhesive and flocking material to the base tape. The second coating of material may optionally be applied to the entire width of the wallboard base tape 10, but most preferably is applied only to the center ¾″ inches of the base tape 10 to provide greater thickness to the center of the tape and to assist in the rigidity and strength of the tape, should the tape be folded in the center as for interior or exterior wallboard corners.

The thickness of each coating of flocking preferably is about 0.002″ to about 0.0325″, more preferably about 0.002″ to about 0.02″, more preferably about 0.002″ to about 0.01″ and most preferably about 0.006″.

When the second flocking layer is applied and applied only to the center ¾″ of the base tape 10, the benefit of not applying much or any wallboard compound to this raised portion is realized. This is particularly useful when the tape is used for inside corner beads as almost none or no wallboard compound need be applied all of the way into the corner. This simplifies the step of sanding the wallboard compound and prevents the installer from having to perform appreciable sanding at the interior corner at the meeting of the two walls, where sanding is difficult.

When wallboard tape is typically applied to a wall, a thin film of wallboard compound is first applied to the wall and the tape applied to the thin film of wallboard compound to ‘seat’ the tape to the wallboard. Next, a thin film of wallboard compound is applied over the tape to cover the tape. After the compound has dried, it is sanded smooth and subsequent coats of drywall compound are applied and sanded as necessary to achieve a smooth joint.

As discussed above, the non-woven base tape provides areas between the fibers where air and wallboard compound can pass. After the flocking step(s), many of these open areas still remain. When the wallboard tape is applied to the base film of wallboard compound, the wallboard compound enters these areas to firmly adhere the tape to the wall. Likewise, when the topcoat of compound is applied to the tape, the compound enters the open areas to further adhere the tape to the wall and the topcoat to the tape. The flocking material also assists in adherence of the compound to the tape and, therefore, the tape to the wall.

The tape 10 has length indicia printed on the edges at regular intervals (such as 6″ or 12″) to make installations of desired lengths very quick and easy.

The tape 10 preferably has a longitudinal rolled or embossed line 100 (FIG. 5) of weakness down the center thereof to facilitate folding the tape 10 along the line of weakness to allow it to be used on interior or exterior corner joints.

Further shown in FIG. 5 as an alternative embodiment the present invention includes stiffening strip 102 of a polyamid hot melt glue applied to the center of the tape 10 to provide additional strength to the center portion of the tape. The strip 102 is preferably about ¼ inch wide and about 0.030 inch thick.

The above examples show that the invention, as defined by the claims, has far ranging application and should not be limited merely to the embodiments shown and described in detail. Instead the invention should be limited only to the explicit words of the claims, and the claims should not be arbitrarily limited to embodiments shown in the specification. The scope of protection is only limited by the scope of the accompanying claims, and the Examiner should examine the claims on that basis.

I claim:

1. A wallboard comprising:
a base tape of nonwoven fibers, the fibers comprising of from about 75%-25% rigid fibers and 25%-75% flexible fibers, the fibers defining openings between said fibers; and
a plurality of discrete fibers adhered to the base tape to form a topcoat, said topcoat fibers comprising a different material than those of the base tape, said topcoat fibers not covering or filling all of said opening such that said openings are capable of receiving a wallboard compound when applied thereto.

2. The wallboard of claim 1 wherein the rigid fibers are fiberglass.

3. The wallboard of claim 1 wherein the flexible fibers are polyester.

4. The wallboard of claim 1 wherein the topcoat fibers are cotton.

5. The wallboard tape of claim 1 wherein the fibers comprise about 66⅔%-33⅓% rigid fibers and about 33⅓%-66⅔% flexible fibers.

6. The wallboard tape of claim 1 wherein the fibers comprise about 50% flexible fibers and about 50% fiberglass fibers.

7. The wallboard tape of claim 1 further comprising a stiffening strip located in substantially the center of the tape.

8. The wallboard tape of claim 7 wherein the stiffening strip is a hot melt glue.

9. A wallboard comprising:
a base tape of nonwoven fibers, the fibers comprising of from about 75%-25% fiberglass fibers and 25%-75% polyester fibers, the fibers defining openings between said fibers; and
a plurality of discrete fibers adhered to the base tape to form a topcoat, said topcoat fibers comprising a different material than those of the base tape, said topcoat fibers not covering or filling all of said opening such that said openings are capable of receiving a wallboard compound when applied thereto.

10. The wallboard of claim 9 wherein the topcoat fibers are cotton.

11. The wallboard tape of claim 9 further comprising a stiffening strip located in substantially the center of the tape.

12. The wallboard tape of claim 11 wherein the stiffening strip is a hot melt glue.

13. A wallboard joint taping system comprising:
two lengths of wallboard abutting one another to form a wallboard joint;
a length of a base tape of nonwoven fibers, the fibers comprising of from about 75%-25% fiberglass fibers and 25%-75% polyester fibers, the fibers defining openings between said fibers, the length base tape applied to the wallboard and over the wallboard joint; and
a quantity of a wallboard compound applied over the joint and the joint tape, the compound permeating the opening between said fibers.

14. The wallboard tape of claim 13 further comprising a plurality of discrete fibers adhered to the base tape to form a topcoat, said topcoat fibers comprising a different material than those of the base tape, said topcoat fibers not covering or filling all of said opening such that said openings are capable of receiving a wallboard compound when applied thereto.

15. The wallboard of claim 14 wherein the topcoat fibers are cotton.

16. The wallboard tape of claim 14 further comprising a stiffening strip located in substantially the center of the tape.

17. The wallboard tape of claim 16 wherein the stiffening strip is a hot melt glue.

18. The wallboard of claim 13 wherein the rigid fibers are fiberglass.

19. The wallboard of claim 13 wherein the flexible fibers are polyester.

20. The wallboard of claim 13 wherein the topcoat fibers are cotton.

21. The wallboard tape of claim 13 wherein the fibers comprise about 66⅔%-33⅓% rigid fibers and about 33⅓%-66⅔% flexible fibers.

22. The wallboard tape of claim 13 wherein the fibers comprise about 50% flexible fibers and about 50% fiberglass fibers.
